(19) United States
(12) Patent Application Publication
(10) Pub. No.: US 2002/0086637 A1
(43) Pub. Date: Jul. 4, 2002

(54) Combined network system and method for providing individualized information from a totality of information items

(76) Inventors: Gero Baese, Muenchen (DE); Martin Gebler, Pulach im Isartal (DE); Sabine Markgraf, Gauting (DE); Annette Schlossnikel, Muenchen (DE); Thomas Strobel, Gauting (DE); Juergen Wilde, Taufkirchen (DE); Andre Fischer, Berlin (DE); Peter Moritz, Haar (DE); Stefan Prange, Muenchen (DE); Arnd Sibila, Moorenweis (DE); Christian Von Brockdorff, Icking (DE)

Correspondence Address: Kevin R. Spivek, Morrison & Foerster LLP, 2000 Pennsylvania Ave., N.W., Washington, DC, 20006-1888, US

(21) Appl. No.: 09/962,795

(22) Filed: Sep. 26, 2001

(30) Foreign Application Priority Data
Sep. 26, 2000 (DE) DE 10047596.5
Mar. 26, 2001 (DE) DE 10115746.0

(51) Int. Cl. H04M 3/42

(52) U.S. Cl. 455/3.02; 455/414

(57) ABSTRACT

The invention relates to a combined network system for providing individualized information from a totality of information items for at least one subscriber (3) to the network system by means of a central unit (1) of the network system, the network system exhibiting at least one broadcasting system (2) for transmitting the totality of information items and at least one mobile communication system (6) for transmitting individualized information to the at least one subscriber (3) and for the interaction of the at least one subscriber (3) to the network system with the central unit (1) of the network system. The invention also relates to a method for providing individualized information from a totality of information items for at least one subscriber (3) to a network system by means of a central unit (1) of the network system.

The present invention relates to a combined network system for providing individualized information from a totality of information items for at least one subscriber to the network system by means of a central unit of the network system and a corresponding method.

With the steadily increasing flood of information, either in written form, for example in the form of newspapers or magazines or via other media such as, for example, television, radio or the Internet, it is very difficult for the individual user of the corresponding media to obtain an overview of all this information. Due to the wealth of information extending over the most varied fields, he is not capable of filtering out the information essential and of interest to him in a rapid and simple manner. Before the user gets to what he is looking for, he must sift through many information items which are not of importance to him. On the one hand, this costs a lot of time which is ineffective for him and, on the other hand, it may also deprive the user of the joy of being always informed.

It is, therefore, an object of the invention to provide a network system by means of which it is possible to provide for a subscriber to the network system individualized information from a totality of information items, i.e. to supply to a subscriber only the information selected by him and of interest to him in order to counteract or prevent by this means an excess of information and, at the same time, to grant interaction to the subscriber to the network system.

This object is achieved by the network system according to the invention according to claim 1. Further advantageous embodiments of the network system are specified in the corresponding subclaims.

According to claim 1, a combined network system for providing individualized information from a totality of information items for at least one subscriber to the network system is provided by a central unit of the network system, the network system exhibiting at least one broadcasting system for transmitting the totality of information items and at least one mobile communication system for transmitting individualized information to the at least one subscriber and for the interaction of the at least one subscriber to the network system with the central unit of the network system.

A combined network is already known in the field of television technology. In the journal Funkschau, edition 11/2000, pp. 28-31, it is described in an article with the title “Hybrid DVB-T and GPRS Networks” that the channel which extends to the television viewer as the subscriber to the network, i.e. the so-called forward channel, runs as a broadcast via a digital terrestrial television channel (DVB-T). Thus, the digital television programs are transmitted in this manner. For the return channel, i.e. for the channel which is intended to establish a connection from the television viewer to the television station, the GPRS (General Packet Radio Service) is used. In addition to the television programs, it is planned to broadcast an HTML (Hypertext Markup Language) based data channel. A television viewer can then access or select data broadcast in the forward channel (DVB-T forward channel) via the return channel.

In the case of the network system according to the invention, in contrast, it is also possible to transmit the individualized information from the totality of information items by means of a mobile communication system from a central unit of the network system to the corresponding subscriber to the network system, i.e., the forward channel can also pass via a mobile communication network in this case. Depending on the selection made by the subscriber to the network system and the desired degree of detail of the representation of the individualized information to be provided, the individualization of the information can run as a service in the central unit of the network system. Thus, only the information already filtered out and edited from the totality of information items is loaded to a display device of the subscriber to the network system. Since, generally, this is a relatively small amount of data which are to be transmitted, this is possible, according to the invention, by means of a mobile communication system. If the subscriber to the network system changes his wishes with regard to the individualized information which is to be provided to him, i.e. if he changes his subscriber profile, this must be in each case reported to the central unit of the network system. According to the invention, this message by the subscriber to the network system is also provided via a mobile communication system. According to the invention, any interaction of the subscriber to the network system with the central unit of the network system takes place via a mobile communication system.

Individualizing the information from a totality of information items can be done in various ways. On the one hand, the subscriber to the network can individualize the content, i.e. he can make a selection in accordance with subject fields such as, for example, sports, commerce, shares, culture, arts, gossip or advertisements. It is also conceivable to specify this selection according to subject fields even further, for example specifically only to select information relating to New Market, Frankfurt, only Formula I-specific information or only economic information from the field of communications engineering. According to the invention, the subscriber to the network is also able to determine the form of representation of the information selected by him or, respectively, the amount of detail with which an information item is to be transmitted. He can decide to have transmitted only headings or only headings with the first section or complete articles.

If a subscriber to the network, for example, has only requested headings from the subject fields selected by him as a form of representation, it is possible, according to the invention, to supply the complete article later if required by means of interaction of the subscriber to the network system with the central unit of the network system. This protects the subscriber from an unnecessary flood of information. He can obtain a very rapid overview of the subjects of interest to him by means of headings or abstracts and, if necessary, become deeper involved in one or the other subject by later requesting the complete article, if desired. This means a great gain in time for the subscriber. He is also able to really exclusively concentrate on the matter he considers relevant.

The provision of individualized information from the totality of information items preferably takes place for a predeterminable selection of subscribers to the network. This means that every subscriber to the network system who wants to request a provision of individualized information from a totality of information items for himself must register for this service, i.e. he must be appropriately subscribed for this service. He then obtains access to the totality of information items and a suitable application software and/or hardware which is compatible with his corresponding terminal, for example with his mobile radio, his laptop or his SIMPAD, and by means of which he can select, store and possibly display and/or print out information from the totality of information items. This preferred embodiment of the network system provides the central unit in the network system, i.e. for example a service provider who collects and possibly purchases the totality of information items from various publishers, agencies and commentators, with the possibility of selectively redistributing his accruing costs to the subscribers to the network registered for this service and, in addition, selectively charging fees for the provision of this service. Furthermore, the provision of such a service is a good advertisement for the service provider which distinguishes him from the competition.

In a preferred embodiment, the broadcasting system for transmitting the totality of information items operates on the basis of satellite television channels (DVB-S) and/or terrestrial digital television channels (DVB-T). The use of DAB (Digital Audio Broadcasting) is also conceivable. This broadcast transmission provides for a relatively rapid and high-quality transmission of a large volume of data, i.e. the totality of information items. The totality of information items thus broadcast is directly accessible, for example, to the corresponding subscriber to the network system so that he can then locally individualize the information desired by him. According to the invention, the desired individualization can also take place in the central unit, provided according to the invention, of the network system where the individualization to be performed for the corresponding subscriber to the network system is stored. According to the invention, the information then individualized is transmitted from the central unit of the network system to the corresponding subscriber by means of a mobile communication system.

In a preferred embodiment, the mobile communication system is implemented by a UMTS (Universal Mobile Telecommunications System) or another 3^{rd}-generation mobile communication system and/or by a GSM/GPRS/EDGE or other 2^{nd}-generation mobile communication system.

By having the possibility of interaction between the central unit of the network system and a correspondingly registered subscriber by means of a mobile communication system, the subscriber can also later request certain information desired by him in a rapid and selective and simple manner whilst traveling, i.e., for example, by means of a mobile radio. If, for example, he finds an interesting event when reading through his individualized information, he can, on the one hand, spontaneously request more detailed information about it and, on the other hand, spontaneously reserve tickets for it. The same thing is conceivable in the case of a travel offer or the like.

Furthermore, it was a further object of the present invention to provide a method for providing individualized information from a totality of information items for at least one subscriber to a network system by means of a central unit of the network system, the method having at least the following steps:

providing a suitable application software and/or hardware for the at least one subscriber to the network system for generating and storing the individualized information from the totality of information items;

transmitting the totality of information items from the central unit of the network system to the at least one subscriber to the network system by means of a broadcasting system and/or

transmitting the individualized information from the central unit of the network system to the at least one subscriber to the network system by means of a mobile communication system.

Preferably, the transmitting of the totality of information items in step b. takes place via a satellite television channel (DVB-S) and/or via a terrestrial digital television channel (DVB-T). The use of DAB (Digital Audio Broadcasting) is also conceivable.

According to the invention, the suitable application software and/or hardware makes it possible for the at least one subscriber to the network to individually select and store, preferably also print out on a suitable printer, information from the totality of information items. The selection of information from the totality of information items can be changed at any time, also quite dynamically, by the subscriber. The method according to the invention, on the one hand, makes it possible to transmit, i.e. to provide, firstly the totality of information items from the central unit of the network system by means of a broadcasting system to the subscriber to the network system. The information is then individualized from the totality of information items locally by the subscriber himself. Furthermore, however, the method according to the invention also opens up the possibility that the individualization of the information from the totality of information items is already performed in the central unit of the network system and only the information already individualized is transmitted from the central unit of the network system to the corresponding subscriber to the network system by means of a mobile communication system. In the latter case, the central unit of the network system must contain stored how the individualization desired by the subscriber has to appear, i.e. there must be a type of subscriber profile. According to the invention, the subscriber to the network system should be able to change his subscriber profile at any time.

In a preferred embodiment of the method, the method has at least the following further steps:

Requesting additional information from the totality of information items by the at least one subscriber at the central unit of the network system by means of a mobile communication system;

subsequent supplying of the additional information from the totality of information items to the at least one subscriber to the network system by the central unit of the network system by means of a mobile communication system.

The subscriber to the network system is thus spontaneously able to broaden his knowledge of subjects of interest to him by requesting further information items. Thus, he selectively obtains more details with respect to a subject, but does not run the risk of obtaining too much, and among this also unnecessary, information which is not of interest to him right from the start. A maximum of individualized information is achieved.

In a further preferred embodiment of the method, the mobile communication network is implemented by a GPRS and/or a UMTS.

Further advantages of the invention will be explained with reference to the following figure, in which:

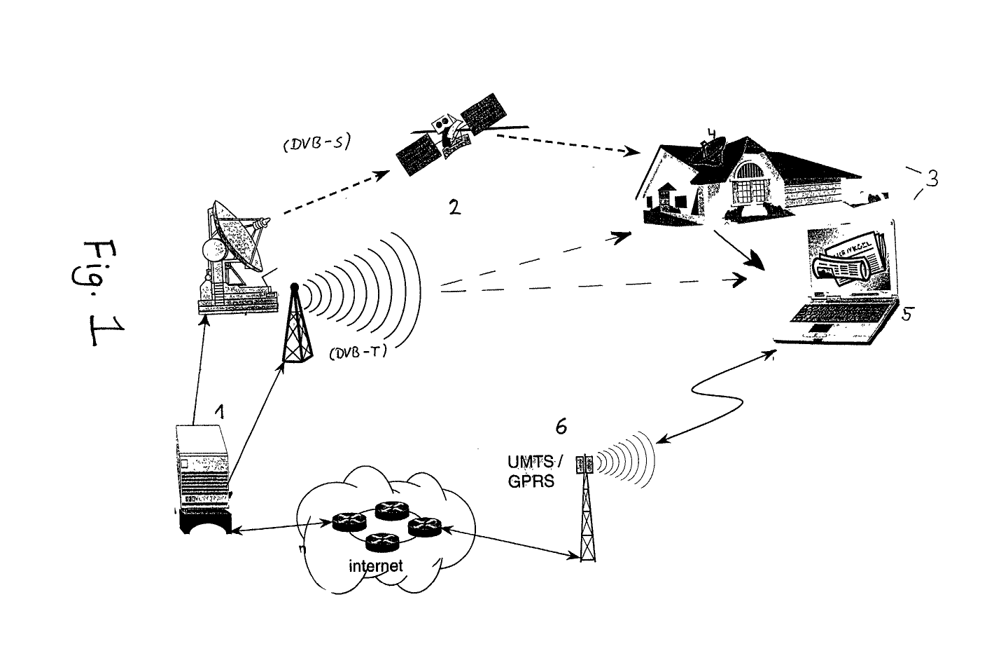

FIG. 1 shows a diagrammatic representation of an embodiment of a network system according to the invention.

FIG. 1 shows an embodiment of a network system according to the invention. A central unit 1, for example a service provider, collects information from various agencies, publishers and other providers and thus provides a totality of information items. The network system according to the invention also exhibits a broadcasting system 2. This is preferably implemented on the basis of satellite television channels (DVB-S) or on the basis of terrestrial digital television channels (DVB-T). The broadcasting system 2 makes it possible to broadcast the totality of information items. In a case where satellite television antennas are used, the totality of information items is preferably received via a permanently installed satellite receiver 4, for example via a satellite dish arranged on the roof of a house and then possibly transferred to a mobile terminal 5 such as, for example, a laptop, a mobile radio or a SIMPAD. When terrestrial digital television channels are used, a direct transmission to mobile communication terminals 5 is conceivable. The subscriber 3 to the network system who is preferably registered for this service at the central unit 1 of the network system can now determine by means of a suitable application software and/or hardware provided on his terminal according to the invention, which information, and in which form of representation, he wishes to receive information from the totality of information items, i.e. he can now himself individualize or, respectively, personalize the totality of information items which has been made accessible to him. He can make a precise selection with regard to the subjects which are of interest to him, and, in addition, he can determine the degree of detail in which the information selected by him is to be supplied to him. This means that he can have transmitted, for example, only headings, headings with leading paragraph or complete articles. Depending on the selection and degree of detail of the representation, the individualization of the information can, naturally, also be performed as a service in the central unit 1 of the network system so that it is only the information already individualized and not the totality of information items which is transmitted to the subscriber 3. This transmission is done preferably by means of a mobile communication system 6 provided according to the invention, which is integrated in the network system according to the invention at the same time as the broadcasting system 2. The mobile communication system 6 is preferably implemented by a UMTS (Universal Mobile Telecommunications System) and/or by a GPRS (General Packet Radio Service). The profile of the subscriber 3 which can be repeatedly updated, i.e. his everlasting capability of changing his individualization is reported in each case to the central unit 1. The mobile communication system 6 thus provides for direct interaction between the corresponding subscriber 3 and the central unit 1 of the network system according to the invention. In addition, it is also possible that, for example, the subscriber 3 has subsequently sent to him a complete article of which he previously only had an excerpt. This, therefore, creates a maximum flexibility of information transmission, especially since this is also possible while traveling, i.e. when mobile. The subscriber 3 can look at the information individualized by him, while underway and without problems, on the one hand, can revise them again and, if necessary, have additional information transmitted within a short time. If, for example, he has discovered an event for which he wants to have tickets, he can also do this on-line.

What is claimed is:

1. A combined network system for providing individualized information from a totality of information items for at least one subscriber (3) to the network system by means of a central unit (1) of the network system, the network system exhibiting at least one broadcasting system (2) for transmitting the totality of information items and at least one mobile communication system (6) for transmitting individualized information to the at least one subscriber (3) and for the interaction of the at least one subscriber (3) to the network system with the central unit (1) of the network system.

2. The combined network system as claimed in claim 1, characterized in that the broadcasting system (2) operates on the basis of satellite television channels (DVB-S) and/or of terrestrial digital television channels (DVB-T).

3. The combined network system as claimed in claim 1 or 2, characterized in that the mobile communication system (6) is implemented by a UMTS (Universal Mobile Telecommunications System) and/or by a GPRS (General Packet Radio Service).

4. A method for providing individualized information from a totality of information items for at least one subscriber (3) to a network system by means of a central unit (1) of the network system, the method having at least the following steps:
Providing a suitable application software and/or hardware for the at least one subscriber (3) to the network system for generating and storing the individualized information from the totality of information items;
transmitting the totality of information items from the central unit (1) of the network system to the at least one subscriber (3) to the network system by means of a broadcasting system (2) and/or
transmitting the individualized information from the central unit (1) of the network system to the at least one subscriber (3) to the network system by means of a mobile communication system (6).

5. The method as claimed in claim 4, characterized in that the transmitting of the totality of information items in step b. takes place via a satellite television channel (DVB-S) and/or via a terrestrial digital television channel (DVB-T).

6. The method as claimed in claim 4 or 5, characterized in that the method has at least the following further steps:
Requesting additional information from the totality of information items by the at least one subscriber (3) at the central unit (1) of the network system by means of a mobile communication system (6);
subsequent supplying of the additional information from the totality of information items to the at least one subscriber (3) to the network system by the central unit (1) of the network system by means of a mobile communication system (6).

7. The method as claimed in one of claims 4 to 6, characterized in that the mobile communication network (6) is implemented by a GPRS and/or a UMTS.
